(19) United States
(12) Patent Application Publication
(10) Pub. No.: US 2017/0093052 A1
(43) Pub. Date: Mar. 30, 2017

(54) ASSEMBLY HAVING TWO COPPER SHEETS SCREWED TO EACH OTHER AND METHOD FOR PRODUCING SAID ASSEMBLY

(71) Applicant: CONTINENTAL AUTOMOTIVE GMBH, HANNOVER (DE)

(72) Inventor: CHRISTIAN BRAUN, LAPPERSDORF/ OT KARETH (DE)

(21) Appl. No.: 15/310,475

(22) PCT Filed: May 11, 2015
(86) PCT No.: PCT/EP2015/060286

§ 371 Date: Nov. 11, 2016

(30) Foreign Application Priority Data
May 14, 2014 (DE) 10 2014 209 146.2

(51) Int. Cl. H01R 4/56; F16B 25/00; F16B 25/10; F16B 5/02

(52) U.S. Cl. CPC H01R 4/56; F16B 5/02; F16B 25/0021; F16B 25/106

(57) ABSTRACT

A method and an assembly use two copper sheets, which are connected to each other by a screw connection. The screw connection is performed by a screw that is screwed directly into the copper sheets without screw holes having been provided. Therefore the production tolerances for preset screw holes can be dispensed with.

Assembly having two copper sheets screwed to each other and method for producing said assembly

In the field of automotive electrics and automotive electronics, in particular in conjunction with the electrification of the motor vehicle, use is made to an increasing degree of consumers that require high currents for operation. In order to keep losses as low as possible, the necessary electrical conductors must have only a small resistance. This can be achieved on one hand by means of correspondingly large cross sections, which is however expensive on account of the correspondingly high material outlay, or on the other hand by means of a correspondingly high conductivity. In this context, copper is still the first choice on account of its properties in this regard. These conductors, often termed busbars, are generally made of copper sheet and must be connected to one another or also with other objects made of copper, such as press-in pins. To that end, connection methods such as riveting, brazing or welding may be considered, although in the case of welding the high heat conductivity of copper is disadvantageous since it means that the welding point does not get hot enough.

DE 199 10 787 A1 teaches screwing copper sheets of this type to one another, although conventionally those parts of the busbars that are to be connected are provided with holes, possibly with a pre-cut thread. However, this implies an additional work step and, moreover, these holes must be created to tight tolerances in order to make the connections of the copper sheets an exact fit.

DE 103 48 427 A1, on the other hand, teaches connecting sheets by direct screwing, wherein by means of an appropriate design of the screw tip and a high rotational speed the screw-in point is subjected to intense heating, making it able to flow, and the screw can be pushed with a suitably high force into the sheets that are to be connected, such that the screw cuts its own thread.

However, according to the disclosure in that document, this connection method is used only for aluminum-steel connections.

The invention has the object of specifying an assembly of two copper sheets that are connected to one another, the production of which has low particle emissions and provides good current transition resistance for high-current connections. The invention has the further object of specifying a method for producing such an assembly.

The object is achieved with an assembly having two copper sheets that are connected to each other by means of a screw connection, wherein the screw is screwed directly into the copper sheets without the provision of screw holes. The object is also achieved with a method for establishing a connection between two copper sheets by means of a screw, in which the screw is screwed directly into the copper sheets without the provision of screw holes.

This makes it possible, for one, to use the screw methods that are widely used in back-end production of motor vehicle electronics, without having to deal with the drawbacks of nut-and-bolt screw connections and correspondingly provided holes in the copper sheets, or threads that must be provided in the holes. In addition, the high degree of heating of the copper at the screw-in point and the fluidity that is achieved thereby make it possible to achieve a very good current-carrying capacity with low transition resistance at the connection point.

In one particularly advantageous embodiment of the assembly according to the invention, at least one of the copper sheets is made of Cu-ETP. This highly conductive copper material is particularly soft and therefore poorly suited to conventional connection methods.

In another inventive embodiment and refinement of the assembly according to the invention, the screw has a thread geometry adapted to the copper material.

In one advantageous embodiment of the method according to the invention, the screwing procedure is performed in a protective atmosphere. This makes it possible to prevent the formation of an insulating oxide on the surface of the copper sheets. The protective gases can be for example argon or carbon dioxide.

In one advantageous embodiment of the method according to the invention, the screwing procedure is performed on a load-bearing support.

The invention will be explained further below with reference to an exemplary embodiment and with the aid of a figure, in which:

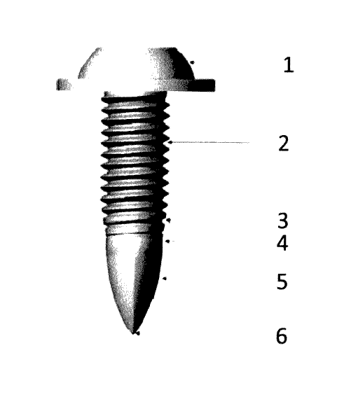

FIG. 1 shows a screw for connecting two copper sheets.

The screw in FIG. 1 has a screw head 1, preferably with a recessed drive. In that context, the diameter of the screw head must be matched to the recessed drive that is to be used, e.g. 2.5 mm for Torx plus. Both the screw material and the recessed drive must be designed for briefly very high rotational speeds of 4000 revolutions per minute and above.

The screw has, at its opposite end from the screw head 1, proceeding from the screw tip 6 to a calibration section 4, a flow hole forming zone 5 which in the example shown is designed as a square that narrows from the calibration section to the screw tip. After the calibration section 4, there follows a short thread-forming zone 3, adjoining which is the load-bearing thread 2.

According to the invention, a screw of this type is pressed with great force, against a load-bearing support, and with high rotational speed against the copper sheets that are to be connected, causing the screw-in point to heat up and to begin to flow, and the screw can cut its own thread. The form-fitting connection achieved thereby results in a low current transition resistance, which is highly advantageous in the case of high-current connections. Furthermore, tolerances of the individual lead frames with respect to each other are not as critical as is the case for a through-hole, since the screw forms the hole itself.

1-6. (canceled)

7. An assembly, comprising:
a screw; and
two copper sheets being connected to each other by a screw connection, wherein said screw is screwed directly into said copper sheets without a provision of screw holes being pre-formed in said copper sheets.

8. The assembly according to claim 7, wherein at least one of said copper sheets is made of Cu-ETP.

9. The assembly according to claim 7, wherein said screw has a thread geometry adapted to a copper material of said copper sheets.

10. A method for establishing a connection between two sheets, which comprises the steps of:
providing two copper sheets; and
screwing a screw directly into the copper sheets without a provision of pre-formed screw holes being provided in the copper sheets.

11. The method according to claim 10, which further comprises performing the screwing step in a protective atmosphere.

12. The method according to claim 10, which further comprises performing the screwing step on a load-bearing support.
